(19) United States
(12) Patent Application Publication
(10) Pub. No.: US 2007/0070059 A1
(43) Pub. Date: Mar. 29, 2007

(54) Refinement of block motion estimate using texture mapping

(76) Inventor: Alan Rojer, Maplewood, NJ (US)

Correspondence Address: LEVISOHN, BERGER & LANGSAM, LLP, 805 THIRD AVENUE, 19TH FLOOR, NEW YORK, NY, 10022, US

(21) Appl. No.: 09/927,614

(22) Filed: Aug. 10, 2001

(51) Int. Cl. G06T 1/00; G06F 17/00

(52) U.S. Cl. 345/418

(57) ABSTRACT

A process for successive refinement to arbitrary precision of a supplied interframe motion estimate for a block of pixels, making use of texture mapping. A bounding box which constrains the limits of the motion estimate must be externally provided, typically one square pixel in size, centered on the original motion estimate. The invention recursively subdivides the supplied bounding box into subregions using a quadtree-like subdivision. A pixel-wise metric comparing the difference between the original block and a prediction for the motion estimate corresponding to each subregion is used to select a particular sub-region from the subdivision for further refinement. The prediction is obtained by texture mapping from the target image using the motion estimate corresponding to the center of the subregion. The precision of the refined motion estimate is controlled by bounding the number of refinement steps. Each refinement step provides a doubling of precision in each of the horizontal and vertical directions.

### BACKGROUND OF THE INVENTION

This invention pertains to the temporal analysis of an image sequence, such as in video or film. In such sequences, there is substantial redundancy between successive frames. Most algorithms for compression of video have made good use of this temporal redundancy to reduce the data requirements for encoded video.

In most current algorithms, images consisting of a rectangular array of pixels are divided into blocks, each of which is essentially a subimage consisting of a rectangle of pixels, often 8×8 or 16×16 pixels. These blocks may be encoded directly as in a keyframe, or they may make use of a prediction typically derived from temporal analysis, which is interframe encoding. In case of interframe encoding, the prediction makes reference to another frame in the sequence, often the predecessor frame, and usually provides a pixel-wise offset to specify a rectangular block within the prediction frame which provides a prediction of the particular block under consideration in the frame which is being regenerated. A residual correction to the pixel values obtained from the prediction is typically provided in the encoding to compensate for the inaccuracy of the prediction.

Selection of predictive blocks for interframe coding has been an area of fertile invention for many years. In general, the selection of a predictive block is based on a restricted search of the prior frame at encoding time. Such a search typically provides an offset to a predictive block in whole (integral) pixel coordinates.

Experience with video encoding and temporal analysis has revealed that viewers are very sensitive to small motions of objects in image sequences; viewer sensitivity is often a small fraction of a pixel for large objects, such as actors in a scene. Hence many algorithms have permitted the use of predictive block offsets at subpixel resolution. Typically these subpixel resolutions are limited to ½ or ¼ of a pixel, which allows an improvement in the quality of the prediction, at the cost of additional computation in encoding and decoding. Subpixel offsets may be obtained by interpolation of the source material, followed by search at higher resolution, or by analysis and interpolation of the error metrics which guide the search for the best integral pixel offset.

The present invention offers a novel approach to obtaining subpixel resolution which is based on the use of texture mapping, a highly effective and widespread technique from computer graphics. In texture mapping, pixels from a reference image are mapped to a surface, which is arbitarily positioned and oriented in the viewing space. This permits a relatively low-resolution model of the geometry of the surface, complemented by a high-resolution representation of the visual texture of the surface. The result is efficient and realistic rendering; hence the wide adoption of the technique.

The present invention uses texture mapping to evaluate predictive offsets at arbitrary resolution. The texture mapper incorporates interpolation as necessary to provide resampling of the predictive image to generate the prediction. The prediction generated by the texture mapping may be evaluated in the usual pixel-by-pixel fashion. This invention discloses a method for the use of texture mapping to successively refine a prediction offset to arbitary resolution.

### SUMMARY OF THE INVENTION

Given a source image and a target image, with a block of N×M pixels in the source image, and a two-dimensional initial motion estimate to a matching N×M block in the target image, the invention will refine the initial motion estimate to arbitrary precision, under any supplied pixel-wise metric.

A bounding-box containing the initial motion estimate is provided, typically one pixel in size when the process is initiated, centered on the initial motion estimate. The error of the initial estimate under the supplied metric at the initial motion estimate is provided. The desired precision is specified as a bound on the number of refinement steps. Each refinement step doubles the precision of the estimate in both x and y dimensions.

In the refinement step, the supplied bounding box is divided into four equal-sized child bounding boxes using the usual quad-tree subdivision, which is well known in the art. The center point of each child bounding box provides a new trial motion estimate. This new trial motion estimate is used to specify a texture map from the target image to the source block. The inverse image of the source block under the texture map is typically not pixel-aligned to the target image. The texture map predicts the source pixels of the block from the target image. The error of prediction is computed pixel-wise in the source image, using the supplied metric. If the limit on refinement steps has not been exceeded, the child with the smallest error is successively refined in a recursive fashion. The refinement step concludes with selection of either the initial motion estimate and its error level, or that of the refinement of the best of its children.

### BRIEF DESCRIPTION OF DRAWINGS

FIG. 1 is a flow diagram of the motion refinement process.

FIG. 2 depicts the source and target images as well as the source block and an initial pixel-wise offset to a prediction block.

FIG. 3 depicts the process of subdivision.

FIG. 4 depicts an example of three successive refinement steps.

FIG. 5 provides an alternative view of the three refimnent steps in FIG. 5, where the scale depicted is doubled with each refinement step.

FIG. 6 is a skeletal listing of the motion refinement algorithm, comparable to FIG. 1.

FIG. 7 provides a skeletal listing of the preferred embodiment of the texture mapping process, using OpenGL.

### DETAILED DESCRIPTION OF THE INVENTION

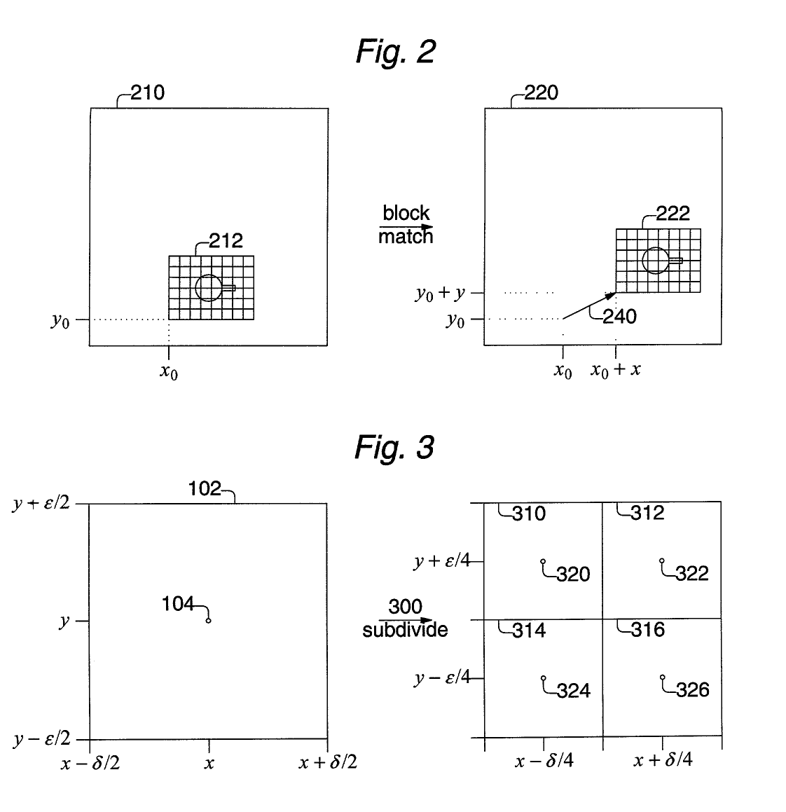

FIG. 2 depicts the context in which the present invention operates. A source image 210 contains a rectangular block of pixels 212. In the preferred embodiment, the rectangular block of pixels 212 is square, with a side length which is a power of 2 (eg, 2×2, 4×4, 8×8, 16×16, etc).

By any of a wide variety of block-matching means which are not disclosed here, but which are well known to those skilled in the art, a pixel displacement 240 has been obtained which relates the source pixel block 212 to a block of pixels 222 in the target image 220. The exact process by which such a block match is obtained is irrelevant to the present invention; however such a match must be provided by some means to initialize the refinement process.

In the preferred embodiment, the source and target images 210 and 220, respectively, are adjacent frames in a sequence of video or film. However the process does not require temporal adjacency of frames, and application of the invention to nonadjacent frames may be useful under some conditions, such as where the motion between frames is very small.

The source block 212 is depicted to have its lower left corner at position x₀, y₀ in the source image 210. The matching target block 222 is depicted to have its lower left corner at postion x₀+x, y₀+y in the target image 220. Hence the initial displacement 240 from source to target is given by x, y. At the outset of the refinement process, the initial displacement 240 provides the best estimate of the motion of the source block 212.

The quality of the initial displacement as a motion estimate may be evaluated using a metric which operates on pixel-by-pixel differences between the source block 212 and the target block 222. Various such metrics are known in the art, of which the most commonly used include L¹, L², and L^{∞}, corresponding to the average of absolute pixel differences, the square root of the average of squared pixel differences, and the maximum absolute pixel difference, respectively. In the preferred embodiment, the L¹ metric (average of absolute pixel differences) is utilized, consistent with its wide use for block matching in the prior art. The selection of the error metric is independent of the present invention, although the results of the refinement will vary as the metric is changed.

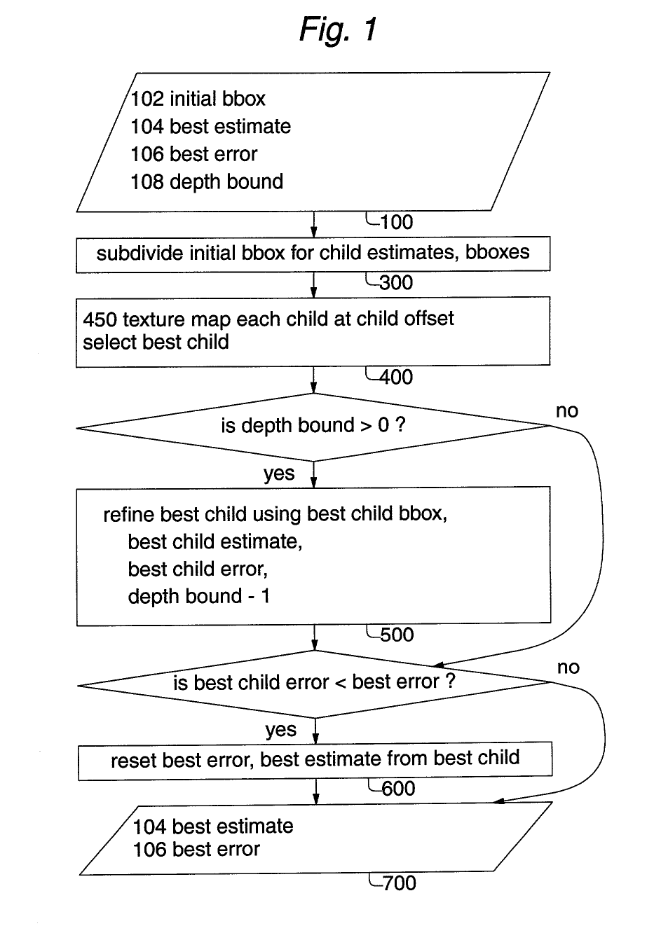

Referring now to FIG. 1, the input 100 to the process consists of an initial bounding box for the search 102, a best estimate of motion 104, a best error 106 associated with the best motion estimate 104, on which the initial bounding box 102 is centered, and a depth bound 108 which limits the number of refinement steps in the process.

To start the refinement process, we obtain the initial bounding box 102 from a block match as depicted in FIG. 2. The center of the initial bounding box is placed at x, y, corresponding to the pixel-wise offset determined by an external block-matching alorithm. In the preferred embodiment, the dimensions of the bounding box are fixed at 1×1 pixel, hence constraining the refinement process to a bounding box ranging from (x−0.5, y−0.5) to (x+0.5, y+0.5) pixels. However, the initial bounding box may be set to some other value, which in general will be of size axe.

We obtain the initial value for the best estimate 104 from the supplied block match, which is presumed to provide at least a local optimum for pixel-wise matches. The best estimate initially is x, y, following the notation of FIG. 2.

The best error 106 is initially obtained by application of the supplied metric between the source block 212 and the target block 222.

The remaining input is the depth bound 108 which limits the number of refinement steps and hence the resolution of the motion vector estimate. As the search space is subdivided by half in each direction for each refinement step, the ultimate precision of the refinement is related to the power of two exponent of the depth. Thus, for a depth bound of 3, the ultimate resolution of the refinement estimate will be ⅛×⅛ pixel. A depth bound of 3 is utilized in the preferred embodiment.

In general, the refinement will be invoked recursively, in each case provided with input 100 comprising an initial bounding box 102 which constrains the search region for the refinement, a best estimate 104 and a best error 106, which may be modified if the refinement detects an improvement, and a depth bound 108 which limits the number of refinement steps and hence the precision of the resolution estimate which the refinement process will obtain.

In the subdivision step 300, the initial bounding box 102 is subdivided into four child bounding boxes. Turning to FIG. 3, the initial bounding box 102 with center 104 at (x, y), occupying the region bounding by (x−δ/2, y−ε/2), (x+δ/2, y+ε/2) is subdivided to four child bounding boxes, 310, 312, 314, 316, each with corresponding centers 320, 322, 324, 326, respectively. The coordinates of the child bounding boxes and their centers may be observed in FIG. 3.

Returning to FIG. 1, in the evaluation step 400, each child bounding box 310, 312, 314, 316, is considered in succession. For each child bounding box, a texture mapping 450 from the target to the source is computed, utilizing the child estimate corresponding to the center of the child bounding box, 320, 322, 324, 326, respectively.

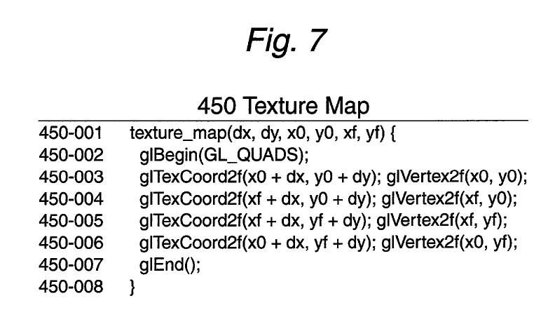

The texture mapping 450 may be performed by a variety of techniques drawn from the prior art. In the preferred embodiment, the freely available Mesa implemention of the standard computer-graphics specification OpenGL has been utilized but other implementations could easily be substituted. FIG. 7 provides a schematic of the OpenGL code which is used to perform the texture mapping. This is a particularly trivial usage of OpenGL texture mapping, utilizing a single quadrangle with two-dimensional coordinates, with a constant translation between each source, target vertex pair.

Returning to FIG. 1, the evaluation step 400 concludes with the selection of the best child from the four children which have been evaluated. Of course, the best child is that which provides the smallest error under the supplied metric.

After evaluation, the depth bound is considered. In the event that the depth bound is positive, one or more additional refinement steps remain to be performed. In this case, the refinement step 500 is invoked. This is a recursive application of the present invention, however, the initial bounding box is reset to the bounding box of the best child, the initial error is set to the error of the best child, and the depth bound is decremented in this recursive invocation. Note that the best child error and corresponding estimate is reset according to the results of the refinement.

Upon completion of the recursive refinement, if any, the best child error is compared to the best error so far. In the event that the best child error is better than the best error so far, the best error and the best estimate are replaced with the respective values obtained from the child in the reset step 600.

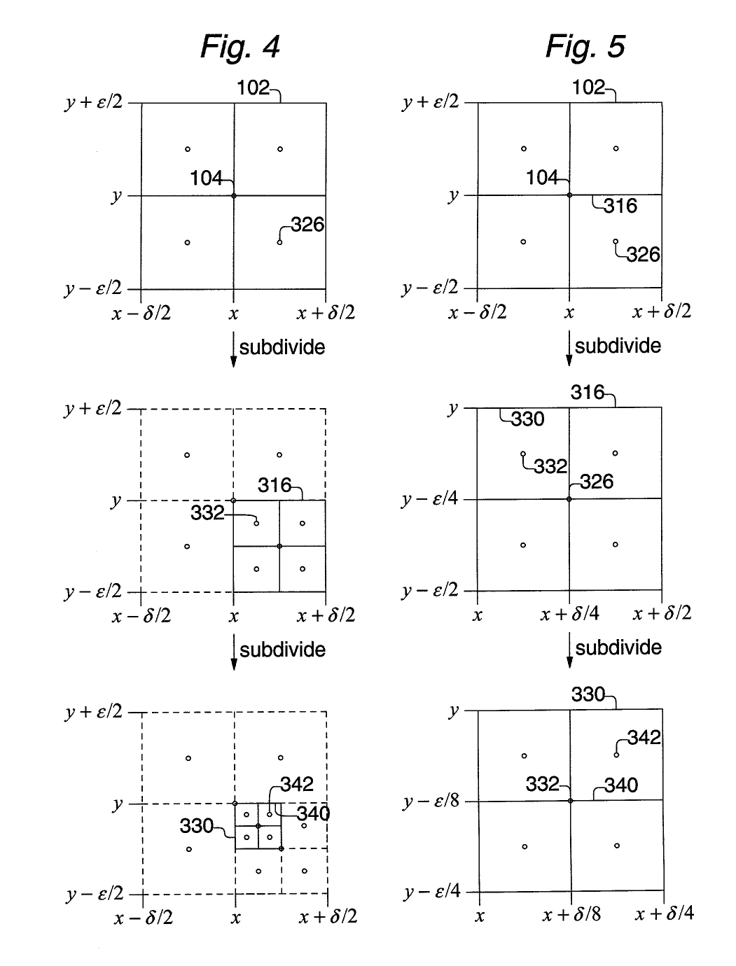

In FIG. 4 and FIG. 5, an example of three steps of refinement is shown in two compound views. The refinement proceeds successively through SE, NW, and NE quadrants, corresponding to 316, 330, 340, respectively, in both Figures. In this example, the evaluation of child motion estimates at successive stages selected 326, 332, 342, respectively, as the best estimate from amongst the child bounding boxes. In FIG. 4, successive views are drawn at the original scale, hence the successive search quadrants may be seen to shrink at each stage. In FIG. 5, each successive view is drawn at double the scale, as indicated by the coordinates on the successive views.

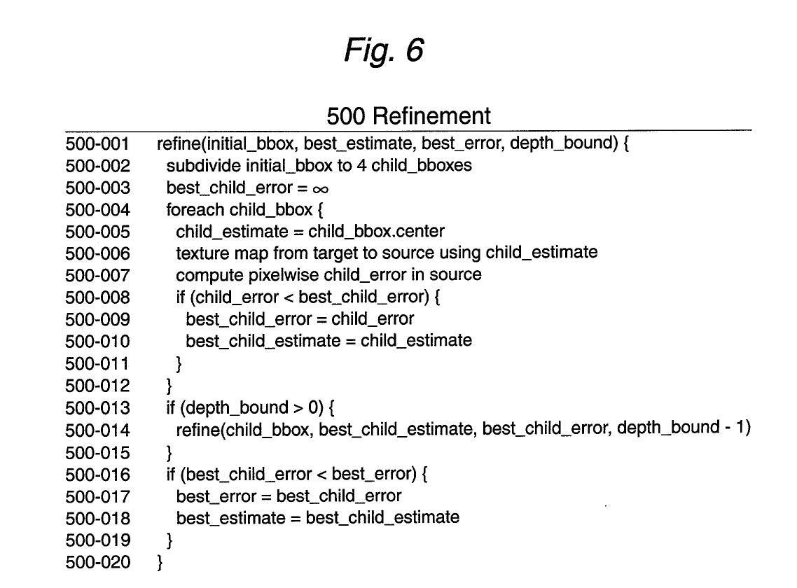

FIG. 6 provides an alternative representation of the present invention, in psuedo-code. Due to the recursive nature of the invention, the algorithm corresponds to the refinement step 500. In FIG. 6, the subdivision 300 from FIG. 1 is carried at at 500-002. The loop 500-003 through 500-012 comprises the evaluation of the child estimates and the selection of the best child, corresponding to the evaluation step 400 in FIG. 1. The optional recursive refinement step 500 is invoked at 500-014. The optional reset of the best estimate and error 600 from FIG. 1 is carried out in 500-016 through 500-019.

I claim:

1. A process for refinement of a motion estimate, comprising the steps of:
accepting input, wherein said input comprises:
a source image,
a target image,
a rectangular source block of pixels in the source image,
a best motion estimate of said block
from said source image to said target image,
a bounding box wherein said bounding box
contains said best motion estimate,
a best prediction error for said best motion estimate,
and
a depth bound to limit the precision of the refinement;
subdividing said bounding box to obtain a plurality of child bounding boxes,
with a child motion estimate for each of said child bounding boxes;
evaluating said child motion estimate for each of said child bounding boxes
to obtain a child prediction error for each of said child bounding boxes;
selecting from said evaluations of said child bounding boxes
a best child bounding box, a best child motion estimate,
and a best child prediction error;
optionally, according to whether said depth bound is greater than zero,
recursively refining said best child bounding box using
said source image,
said target image,
said source block,
said best child motion estimate,
said best child bounding box,
said best child prediction error,
and
said depth bound less one;
optionally, according to whether said best child prediction error is smaller
than said best prediction error,
resetting
said best prediction error
and
said best motion estimate
to
said best child prediction error
and
said best child motion estimate,
respectively;
and
providing output, wherein said output comprises
said best prediction error and said best motion estimate.

2. The process of claim 1,
wherein said subdivision step uses a quadtree subdivision
providing four child bounding boxes.

3. The process of claim 1,
wherein said child motion estimate for each of the said child bounding boxes is the center of said child bounding box.

4. The process of claim 1,
wherein said evaluation step for each of said child bounding boxes
is a process comprising the steps of:
texture mapping of a rectangular region in said target image,
said rectangular region of size equal to said source block,
and
said rectangular region displaced translationally
from the the position of said source block
according to said child motion estimate for said child bounding box,
wherein said texture mapping provides a prediction block
comprising a rectangular block of pixels
of equal size to said source block;
and
computation of said child prediction error using
a pixel-wise metric between said source block and said prediction block.

5. The process of claim 4,
wherein said pixel-wise metric is the L¹ metric, that is,
the average of the absolute differences
between said source block and said prediction block
on a pixel by pixel basis.

6. The process of claim 4,
wherein said pixel-wise metric is the L² metric, that is,
the square root of the average of the squared differences
between said source block and said prediction block
on a pixel by pixel basis.

7. The process of claim 4,
wherein said pixel-wise metric is the L²⁸ metric, that is,
the maximum of absolute differences
between said source block and said prediction block
on a pixel by pixel basis.

8. A process for refinement of an initial motion estimate
for a block of pixels between a source and a target image,
comprising the steps of:
generating a succession of trial motion estimates;
predicting said block of pixels for each of said trial motion estimates
by texture mapping from the target image
according to each trial motion estimate;
evaluating each of said predictions using a supplied pixel-by-pixel
metric to provide a measure of error;
and
selecting that trial motion estimate
from said succession of trial motion estimates
which minimizes said measure of error.

9. The process of claim 8, wherein
an initial bounding box is selected
such that the center of said initial bounding box
is said initial motion estimate;
and
said succession of trial motion estimates is obtained
by selection of the centers of bounding boxes obtained
by recursive quad-tree subdivision of the initial bounding box.

10. The process of claim 9, wherein said initial bounding box
is selected to have a dimensions of 1×1 pixels.

11. The process of claim 9, wherein
said quad-tree recursive subdivision of bounding boxes is restricted
to the particular bounding box at each recursive step
which minimizes said measure of error
obtained by said prediction and said evaluation
of the trial motion estimate associated with each successive bounding box.

12. The process of claim 8, wherein
the prediction step consists of texture mapping
a region of size equal to said block of pixels from said target image
where said region in said target image
is displaced from the position of said block of pixels in said source image
by translation according to said trial motion estimate.

13. The process of claim 8, wherein
said measure of error in said evaluation step
is the L¹ metric, that is,
the average of the absolute differences
between said source block and said prediction block
on a pixel by pixel basis.

14. The process of claim 8, wherein
said measure of error in said evaluation step
is the L² metric, that is,
the square root of the average of the squared differences
between said source block and said prediction block
on a pixel by pixel basis.

15. The process of claim 8, wherein
said measure of error in said evaluation step
is the L^{∞}metric, that is,
the maximum of absolute differences
between said source block and said prediction block
on a pixel by pixel basis.
